(19) United States
(12) Patent Application Publication
(10) Pub. No.: US 2026/0125173 A1
(43) Pub. Date: May 7, 2026

(54) CONTAINER ORIENTING SYSTEM AND DEVICE

(71) Applicant: Auto-Kaps LLC, Riverhead, NY (US)

(72) Inventors: Kenneth J. Herzog, Riverhead, NY (US); Michael Herzog, Riverhead, NY (US)

(21) Appl. No.: 19/374,614

(22) Filed: Oct. 30, 2025

Related U.S. Application Data
(60) Provisional application No. 63/715,158, filed on Nov. 1, 2024.

(51) Int. Cl. B65B 35/58; B65G 47/248; B67C 3/24

(52) U.S. Cl. CPC B65B 35/58; B65G 47/248; B67C 3/24; B65G 2201/0244

(57) ABSTRACT

A bottle orienting system and device includes a hook configured to engage an open end of a container and rotate to move the container into an open end trailing configuration. A biasing element is provided to limit rotation of the hook and to rapidly return the hook to a start position to properly orient a second bottle. In embodiments, different shapes may be used for the hook. In embodiments, the hook may be mounted without rotation.

### CROSS-REFERENCE TO RELATED APPLICATIONS

The present application claims benefit of and priority to U.S. Provisional Patent Application Ser. No. 63/715,158 filed Nov. 1, 2024 entitled CONTAINER ORIENTING SYSTEM AND DEVICE, the entire content of which is hereby incorporated by reference herein.

### BACKGROUND

### Field

The present application relates to a container orienting system and device used to arrange containers in a desired configuration, preferably for further processing, for example, in a bottle filling and capping machine. More specifically, the container orienting system and device includes a rotating hook element that is used to orient containers as desired.

### Description of the Art

Container processing systems and devices generally include a device or devices that are used to arrange or orient containers as they move through the system. For example, filling and capping machines include a device that arranges bottles in a desired orientation so that they can be properly processed for filling, capping or other processing. There are a variety of mechanisms that may be used to orient containers, however, these contemporary devices are overly complicated. The complicated nature of such conventional devices also reduces the speed at which the processing machines can work which reduces the overall efficiency of the system.

Accordingly, it would be beneficial to provide a container orienting system and device that avoids the problems noted above.

### SUMMARY

A container orienting system includes an orienting device that, in embodiments, includes a rotating hook portion that selectively engages an open end of the container when the container is in an open end forward orientation and rotates the container to a closed end forward orientation. In embodiments, a biasing element is provided to return the hook portion to a start position suitable to engage another container after the hook element has rotated a predetermined amount sufficient to alter the orientation of the container. In embodiments, a shock absorbing member may be provided to absorb some of the force of the hook as it returns to the start position to reduce shock and wear and tear.

A container orienting system in accordance with an embodiment of the present disclosure includes: a first belt operable to advance a first bottle in a first direction; a movable orienting device movable from a first position in which at least a portion of the movable orienting device extends upward relative to a lower surface of the bottle as it advances in the first direction and positioned in a path of travel of the first bottle and a second position in which the portion of the movable orienting device moves to a second position, the orienting device including a hook provided in the portion of the movable orienting device that extends upward such that the hook engages a neck of the first bottle positioned in a neck forward position causing the orienting device to move and flip the bottle to a neck trailing position as the bottle moves in the first direction.

In embodiments, the orienting device moves from the first position to the second position with the hook sliding along a bottom wall and side wall of a second bottle when the second bottle is in the neck trailing position such that the second bottle passes over the orienting device without changing orientation.

In embodiments, the hook includes a notch portion that receives the neck of the first bottle.

In embodiments, a size of the notch is varied to accommodate bottles of different sizes.

In embodiments, the orienting device includes: a rotating arm, rotating from the first position to the second position, wherein the portion of the movable orienting device that extends upward is provided at a distal end of the rotating arm and the hook is provided at the distal end of the rotating arm; an axel rotatably mounted in a stationary base such that the rotating arm rotates with the axel from the first position to the second position to flip the first bottle when the neck of the first bottle is engaged with the hook of the rotating arm; and a biasing element limiting rotation of the rotating arm to a desired angle and biasing the rotating arm into the first position.

In embodiments, the rotating arm includes a first stop extending from a surface thereof and in contact with one end of the biasing element.

In embodiments, the base includes a second stop extending from a surface thereof and in contact with a second end of the biasing element such that the biasing element limits rotation of the rotating arm relative to the base to a desired angle and biases the rotating arm in the first position.

In embodiments, the orienting device includes a resilient member mounted adjacent to a proximal end of the rotating arm and in contact with the proximal end when the rotating arm returns to the first position to absorb force exerted by the proximal end of the rotating arm.

In embodiments, the system includes a deflector element spaced away from the orienting device in the first direction and above a top surface of the first bottle to guide the first bottle downward after passing the orienting device.

In embodiments, the system includes a second belt, wherein the second belt is positioned opposite the first belt with the first bottle positioned between and in contact with the first belt and the second belt, wherein the first belt and the second belt advance the first bottle in the first direction.

In embodiments, the hook extends upward and is positioned in the path of the first bottle in the first position such that it engages the neck of the first bottle as it advances in the first direction when the first bottle is in the neck leading position, and the hook slides downward along a ramp on which it is mounted to flip the first bottle to a neck trailing position as it moves to the second position.

In embodiments, the hook orienting device moves from the first position to the second position along the ramp with the hook sliding along a bottom wall and side wall of a second bottle when the second bottle is in the neck trailing position such that the second bottle passes over the orienting device without changing orientation.

In embodiments, the orienting device includes a biasing element biasing the hook into the first position where it will engage the neck of the first bottle in the neck forward position.

In embodiments, the hook includes a notch that receives the neck of the bottle.

In embodiments, a size of the notch varies to accommodate bottles of different sizes.

In embodiments, the second position may be varied based on a strength of the biasing element.

In embodiments, the second position may be varied based on positioning of a stop on the ramp.

A bottle orienting system in accordance with another embodiment of the present disclosure includes: a first belt operable to advance a first bottle in a first direction; an orienting device that extends upward relative to a lower surface of the bottle as it advances in the first direction and positioned in a path of travel of the first bottle, the orienting device including a hook provided on one end thereof such that the hook engages a neck of the first bottle positioned in a neck forward position; a transverse slot provided in the orienting device and spaced from the hook such that the bottle pivots around the hook into a neck trailing position as it moves in the first direction.

In embodiments, the hook includes a notch that receives the neck of the bottle.

In embodiments, a size of the notch varies to accommodate bottles of different sizes.

### BRIEF DESCRIPTION OF THE DRAWINGS

FIG. 1 illustrates an exemplary container orienting system that may include the container orienting device in accordance with an embodiment of the present invention;

FIG. 2 illustrates a more detailed view of the rotating hook used in the container orienting device from a downstream end in accordance with an embodiment of the present invention;

FIG. 2A illustrates a side view of the rotating hook of FIG. 2; and

FIG. 2B illustrates an opposite side view of the rotating hook of FIG. 2;

FIG. 2C illustrates a side view of the rotating hook suitable for use in the container orienting device in accordance with an embodiment of the present disclosure;

FIG. 2D illustrates a rear perspective view of the rotating hook of FIG. 2C;

FIG. 3 illustrates a more detailed view of the rotating hook including a notch formed therein to engage an open end of a container as it approaches the hook in accordance with an embodiment of the present invention;

FIG. 4 illustrates a detailed view of the hook entering an open end of the container in accordance with an embodiment of the present invention;

FIG. 5 illustrates a detailed view of the hook rotating as the container advances forward with the hook in the open end of the container in accordance with an embodiment of the present invention;

FIG. 6 illustrates a more detailed view of a coil spring that may be used in the biasing element used to bias the rotating hook into the start position of FIGS. 2-3 in accordance with an embodiment of the present application;

FIG. 7 illustrates a more detailed view of a rotatable axle that rotates with the rotating hook in accordance with an embodiment of the present disclosure;

FIGS. 8A-8D illustrates the container rotating from an open end leading orientation to an open end trailing orientation in accordance with an embodiment of the present disclosure;

FIG. 9A-9D illustrates a detailed view of a container approaching the rotating hook in an open end trailing orientation in accordance with an embodiment of the present disclosure;

FIG. 10 illustrates a hook of the container orienting device in accordance with another embodiment of the present invention;

FIG. 11 illustrates a hook of the container orienting device in accordance with an embodiment of the present disclosure;

FIG. 12 illustrates a hook of the container orienting device in accordance with another embodiment of the present application;

FIG. 13 illustrates a deflector that may be used to direct containers downward after they pivot in accordance with an embodiment of the present disclosure; and

FIG. 14 illustrates a hook of the container orienting device in accordance with an embodiment of the present disclosure.

### DESCRIPTION OF THE EMBODIMENTS

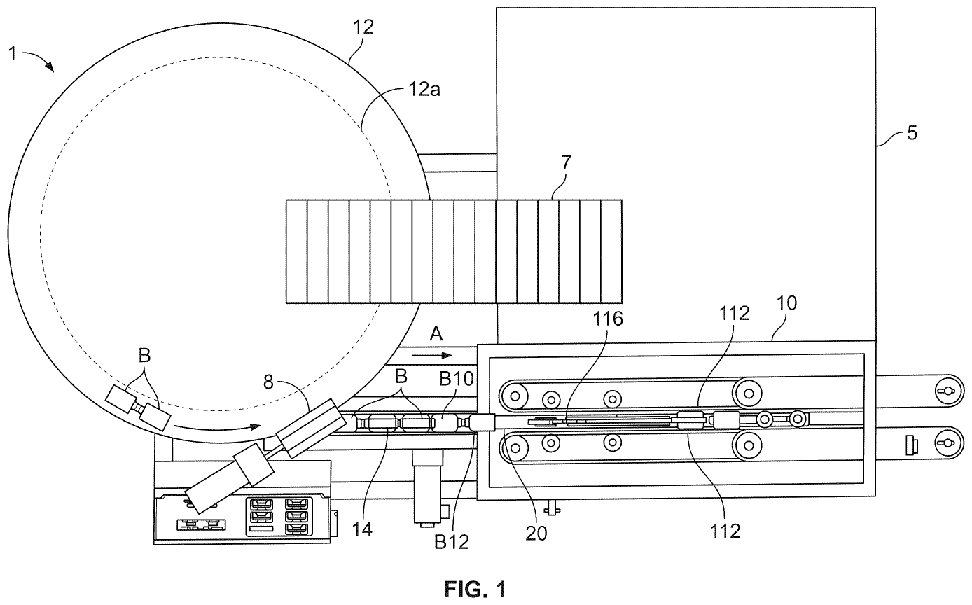

An exemplary embodiment of a bottle orienting system 1 using bottle orienting device 10 of the present application is illustrated in FIG. 1. In embodiments, bottles B are provided to the system 1 and generally include a neck adapted to receive a cap or other closure, and an opening to allow the bottles to be filled. While FIG. 1 illustrates a plurality of bottles B, the orienting system 1 and the orienting device 10 may be used to orient other containers that include an open end. In embodiments, as can be seen in FIG. 1, the bottles B may be provided to a rotary feeder 12, preferably via a storage hopper 5 and elevator belt device 7, however, any suitable mechanism for providing the bottles B, or other containers, may be used. In embodiments, a rotating disc 12a may be provided in the rotary feeder 12 to rotate at a desired speed to force the bottles B to the outer periphery of the disc 12a. In embodiments, the bottles B, or other containers, are lying on their side in a horizontal position with either a neck (or other open end) trailing or neck (or other open end) leading position.

In embodiments, the bottles B may be provided from the feeder 12 to the metering belt 14 which transports the bottles, or other containers, in a single line toward the orienting device 10. In embodiments, the metering belt 14 may be a rubber motorized belt that moves the bottles B in the direction of arrow A and may be bottom mounted, that is, positioned under the bottles B, as illustrated in FIG. 1, or side mounted, that is, adjacent to the bottles. In embodiments, a paddle wheel 8 may be used to move bottles that are vertical into a horizontal, lying down positions prior to entering the feeder 12 to the metering belt 14. In embodiments, any suitable structure may be used to move the bottles from a vertical to horizontal orientation. In embodiments, the metering belt 14 may be made of any suitable material. As the bottles or other containers are fed into the metering belt 14, they may be in a neck leading orientation, for example, bottle B10, or a neck trailing orientation like bottle B12.

In embodiments, the bottles B, B10, B12 then pass to the orienting device 10. In embodiments, the bottles B, B10, B12 move from the metering belt 14 to a bottom guide 20 on which they slide as they pass through the device 10. In embodiments, the bottom guide 20 may simply be a substantially flat and low friction surface as indicated in FIG. 1. Alternatively, in embodiments, the guide 20 may simply include two elongated and spaced apart bars that extend parallel to the direction of travel of the bottles B, B10, B12 over the length of the device 10 where the lateral spacing between the bars is smaller than a width of the bottles B, B10, B12, or other containers, so that a bottle, or other container, lying on top of the bars will simply slide along on the bars without falling between them. In embodiments, a single elongated guide bar may form the bottom guide 20. In addition, the bottom guide 20 may be eliminated altogether. In embodiments, the guide 20 may include other structures as well to guide the bottles B, B10, B12 to the orienting device 10.

In embodiments, at least one side belt 112 may be provided to advance the bottles B, B10, B12 in the direction of arrow A through the orienting device 10. In embodiments, the belt 112 may be provided adjacent to the path of travel of the bottles B, B10, B12, or other containers, and urges the bottles or containers in the direction of arrow A. In embodiments, two side belts 112 are provided, one on each side of the line of bottles B, B10, B12.

In embodiments, where two side belts 112 are used, the bottom guide 20 may be eliminated altogether with the bottles B, B10, B12, or other containers, held up and moved forward by the side belts alone.

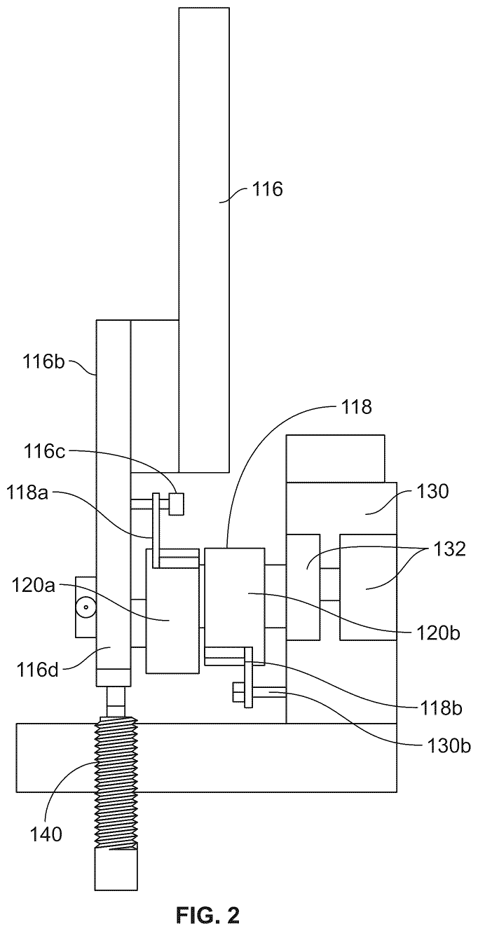

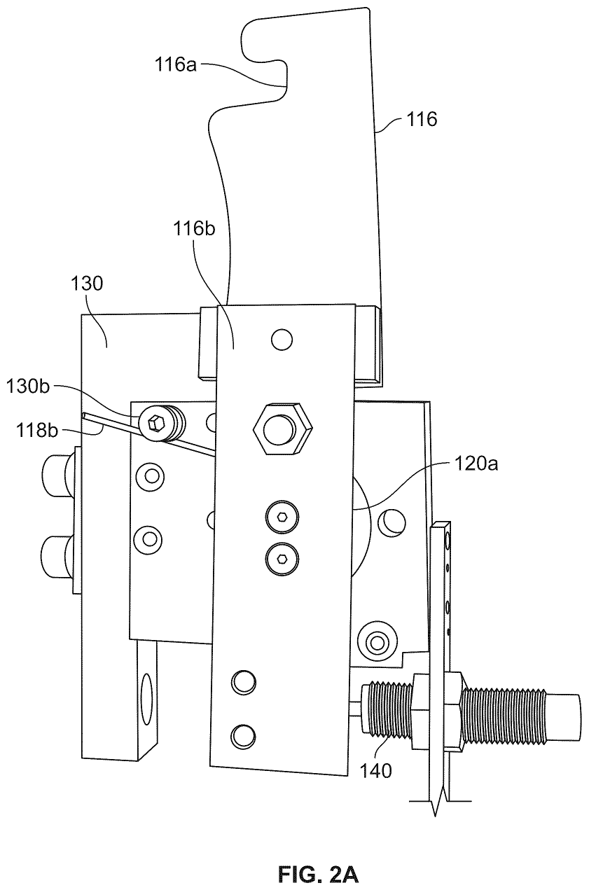

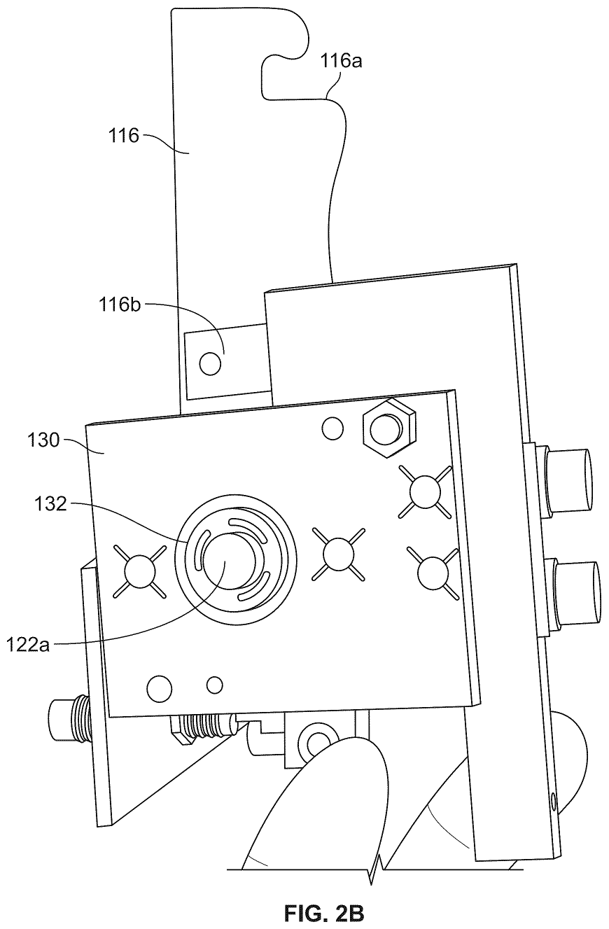

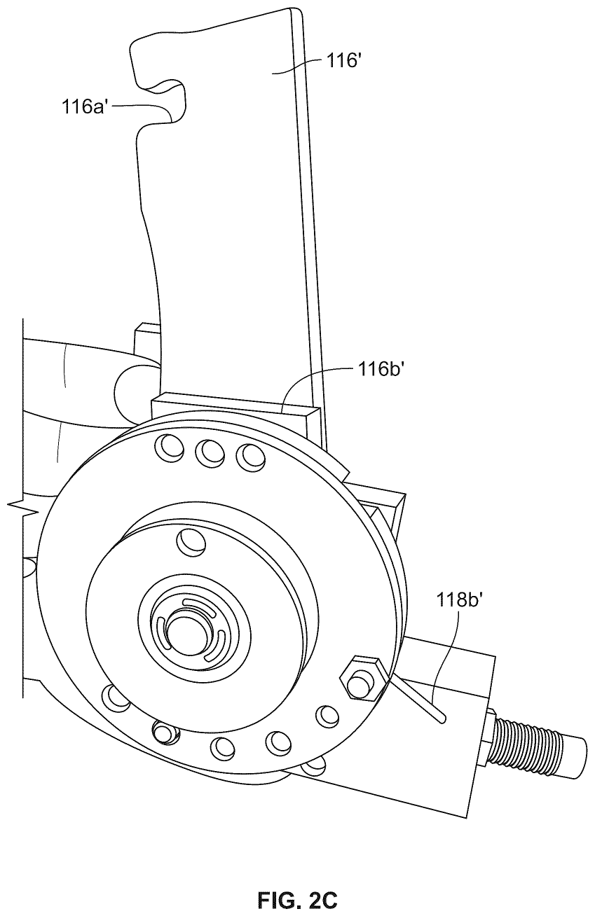

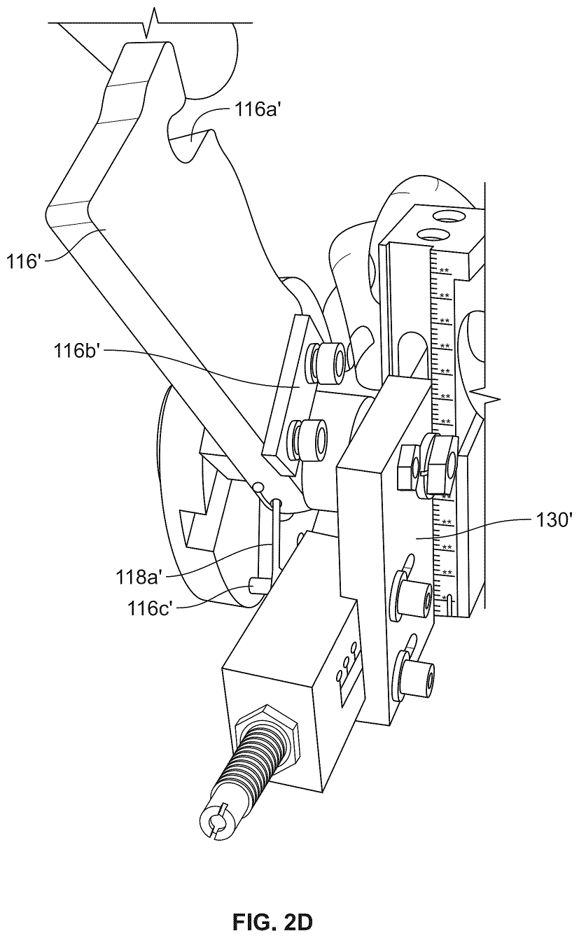

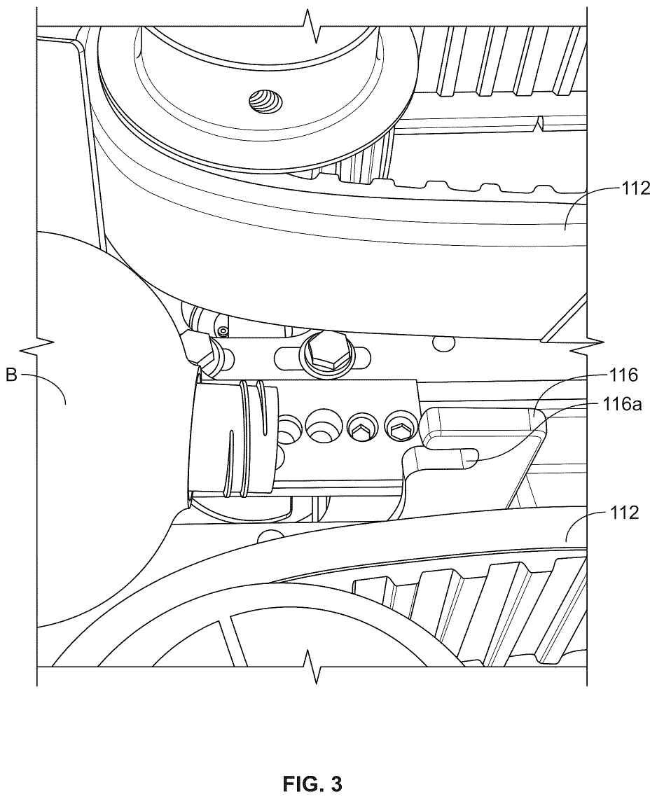

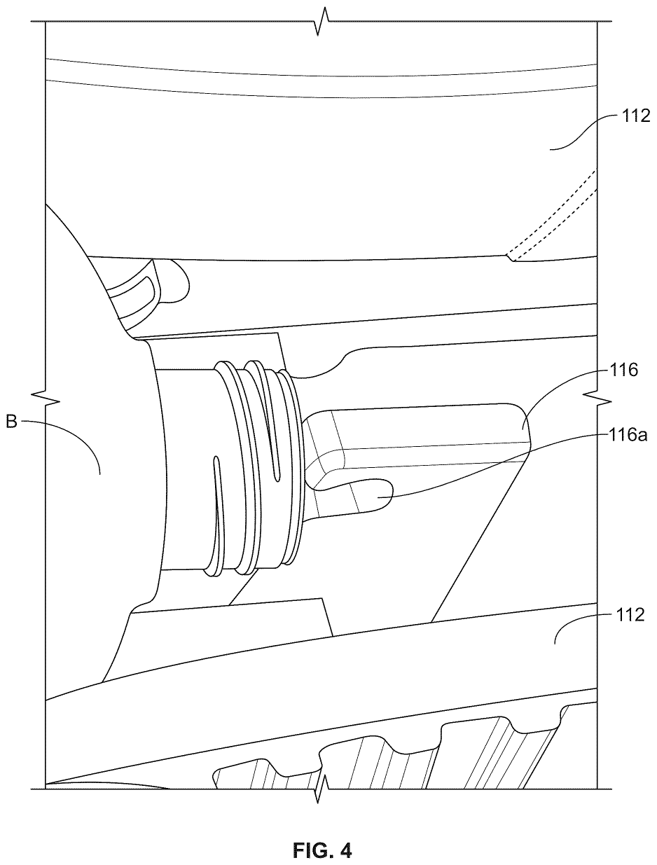

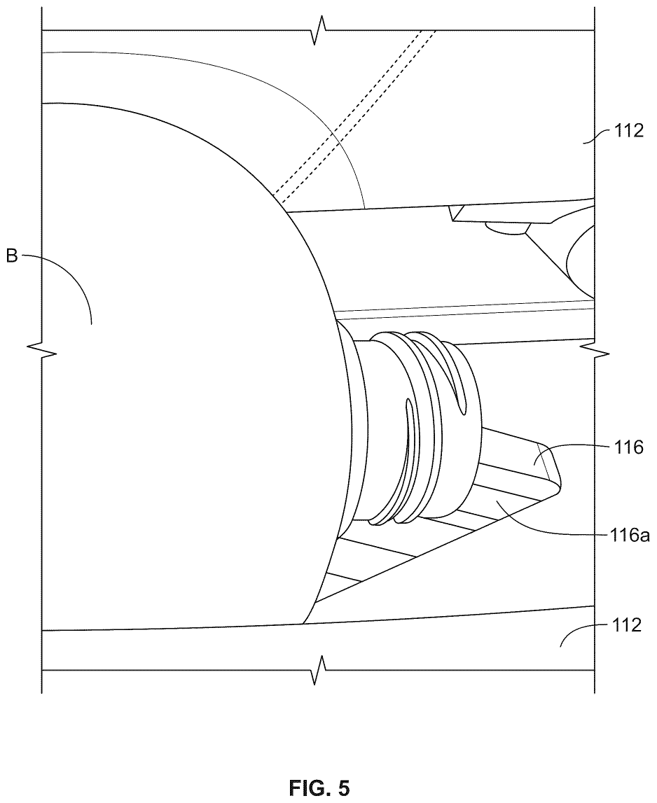

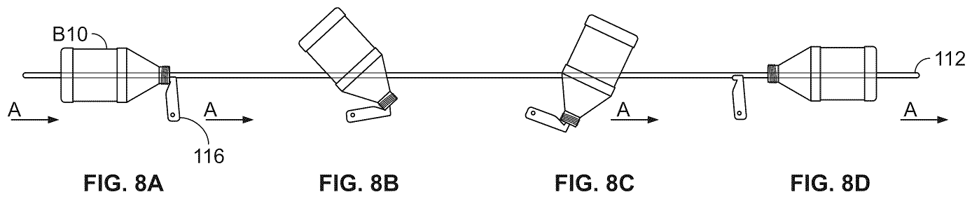

In embodiments, a rotating hook 116 is mounted in the device 10 such that it extends upward above a top surface of the guide 20 and in the path of the bottles B, B10, B12, or other container. Where no guide 20 is used, the rotating hook 116 may be mounted in the device 10 such that it extends upward relative to the lowest surface of the bottle, or other container, as it is advanced between the belts 112. A more detailed view of an embodiment of the rotating hook 116 is illustrated in FIG. 2. In embodiments, the rotating hook 116 may be mounted on a top of a rotating arm 116b such that the hook and the arm rotate out of the page in FIG. 2, to the right in FIG. 2A and to the left in FIG. 2B. The arrow A also corresponds to the out of the page direction of FIG. 2, to the right in FIG. 2A and to the left in FIG. 2B. In embodiments, a bottle/container facing portion of the hook 116 includes a notch 116a configured such that the hook 116 engages the open end of the bottle B (or other container) when the bottle is in a neck (or open end) forward position, such as the bottle B10 in FIG. 1 and FIGS. 8A and 8B. The notch 116a can be seen in FIGS. 2A, 2B and 3, for example. In embodiments, a size of the notch 116a may be varied to accommodate different bottles or containers. In embodiments, the position of the notch 116a may also be varied to accommodate different bottles or containers. FIGS. 4 and 8B illustrate the hook 116 entering the open end of a bottle B10 while FIGS. 5 and 8C illustrate the hook 116 rotating as the bottle B10 is advanced through the device 10 by the belts 112. In embodiments, the notch 116a allows the top portion of the hook 116 to enter the open end of the bottle B10 or other containers as they travel in the direction of arrow A whether they slide along the guide 20 or are carried between the belts 112. As the bottle B10 advances, the hook 116 rotates as can be seen in FIGS. 8B and 8C, for example.

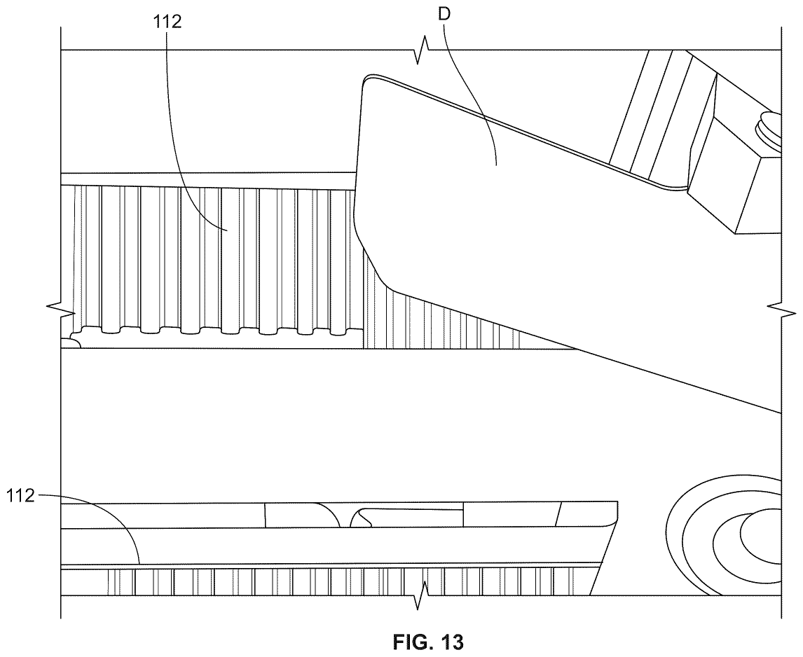

In embodiments, a biasing element 118 is provided to limit rotation of the arm 116b and the hook 116. When the arm 116b and the hook 116 reach maximum desired rotation, the bottle or other container rotates about the open end to change its orientation from open end forward to open end trailing as can be seen in FIGS. 8C and 8D. In embodiments, after the bottle B or other container has passed by the hook 116, the biasing element 116 returns the hook 116 to the start position illustrated in FIGS. 2, 2A, 2B and 8D, for example, such that it may engage another bottle. In embodiments, the rotation of the hook 116 is limited to about 90 degrees. In embodiments, the rotation of the hook 116 may be less than 90 degrees, In embodiments, rotation of the hook 116 may be more than 90 degrees. In embodiments, a top deflector D (see FIG. 13) may be mounted above the guide surface 20 downstream of the rotating arm 116 to guide the bottle or container back into a horizontal orientation after the bottle or container rotates into the open end trailing position. In embodiments, the deflector D may not be used.

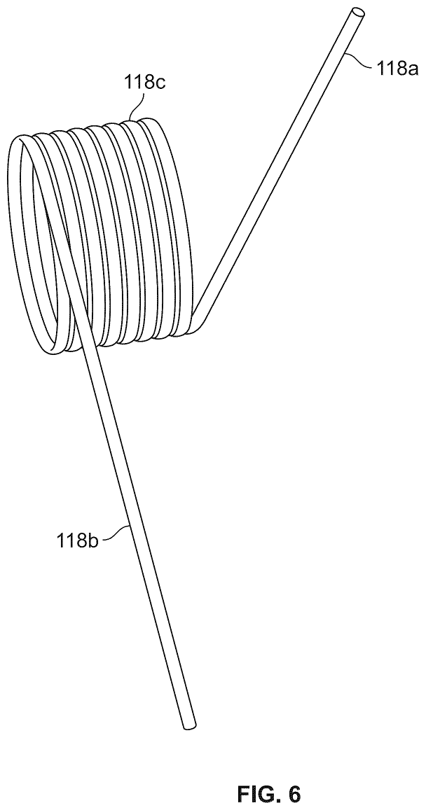

In embodiments, the biasing element 118 may be or include a coiled spring with a coil portion 118c including a first leg 118a extending laterally from a first end thereof and a second leg 118b extending laterally from an opposite end thereof. In embodiments, the first leg 118a extends at an angle of substantially ninety degrees with respect to the second leg 118b as can be seen in FIG. 6, for example. In embodiments, this angle may be a bit larger or a bit smaller. In embodiments, the spring constant of the biasing element 118 may be selected to provide more or less biasing force depending on a size of the bottle B and/or the speed of the system 1. In embodiments, the coil spring of the biasing element 118 may be mounted in a cover element 120 including a first cover element 120a from which the leg 118a extends and a second cover element 120b from which the leg 118b extends such that the cover elements are movable independent of each other.

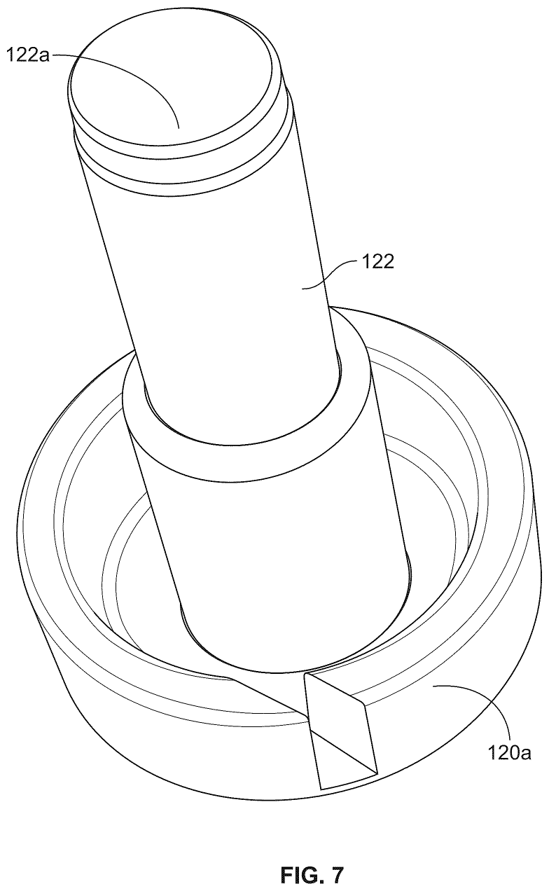

In embodiments, the rotating arm 116b may be connected to an axle 122 (see FIGS. 2B and 7, for example) that passes through the center of the coil portion 118c of the biasing element 118. The axle 122 is rotatably mounted in a block 130 via one or more bearings 132 (see FIGS. 2 and 2B) such that the axle rotates the arm 116b and the hook 116 relative to the block. In embodiments, the block 130 may be secured to the system 1 such that the arm 116b and hook 116 rotate relative to the base 130 and the system 1. In embodiments, the distal end 122a of the axle 122 is rotatably mounted in the bearing 132 as can be seen in FIG. 2B, for example.

In embodiments, the rotating arm 116b includes a first stop element 116c that is in contact with the first leg 118a of the biasing element 118. In embodiments, the base 130 may include a second stop element 130b that is in contact with the second leg 118b of the biasing element 118. As the bottle B10, or other container, moves in the direction A, the hook 116 engages the open end and the arm 116b (see FIG. 8A, for example), the hook 116 and the axle 122 rotate out of the page in FIG. 2, to the right in FIG. 2A and FIG. 8B and to the left in FIG. 2B. The biasing element 118 and the stops 116c and 130b limit the amount of rotation permitted for the hook 116 as can be seen in FIG. 8C. Once the hook 116 stops rotating, the bottle B10 or other container continues in the direction A, driven by the belts 112 such that the container flips into an open end trailing orientation as is illustrated in FIG. 8D discussed above. The bottle or other container will then continue in the direction A in this orientation and may be further processed. In embodiments, the biasing element 118 returns the hook 116 to the start position of FIGS. 2, 2A, 2B, 3 and 8D, for example, such that it is positioned for use with the next bottle B or other container.

In embodiments, a resilient member 140 may be provided to contact a bottom end 116d of the arm 116b when the hook is returned to the start position. In embodiments, the resilient member 140 may include a piston that absorbs some of the energy of the return of the hook 116 to the start position which allows the hook to reset more quickly and also reduced wear on the arm 116b. In embodiments, the resilient member 140 may be any suitable resilient element that absorbs at least some of the energy of the arm 11 as it is forced back to the start position by the biasing element 118.

In FIGS. 2C-2D, another embodiment of the hook 116′ is illustrated. The hook 116′ includes a notch 116a′ which is smaller than the notch 116a discussed above, but otherwise operates in substantially the same manner. The hook 116′ is connected to rotating arm 116b′ and a stop 116c′ is provided on the outer circular portion of the arm that interacts with the leg 118a′. In embodiments, the base 130′ includes a stop (not shown) that engages the leg 118b′ of the biasing element 118. As the bottle B10, or other container, moves toward the hook 116′, the hook 116′ engages the open end and the arm 116b′, the hook 116′ rotates. The biasing element 118′ and the stops 116c′ and 130b′ limit the amount of rotation permitted for the hook 116′. Once the hook 116′ stops rotating, the bottle B10 or other container continues to move, driven by the belts 112 such that the container flips into an open end trailing orientation in a manner similar to that described above. In embodiments, the biasing element 118′ returns the hook 116′ to the start position such that it is positioned for use with the next bottle B or other container.

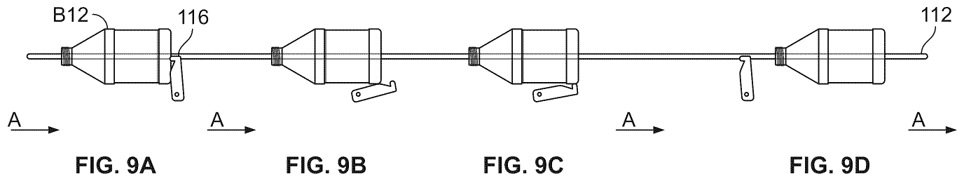

In embodiments, when a bottle B12 approaches the hook 116′ in a neck, or open end trailing position (see FIG. 9A, for example), the hook 116, 116′ does not engage the open end of the container or bottle B12 as can be seen in FIGS. 9B-9C, for example. In this case, the bottle B12 approaches the hook 116 116′ with its bottom facing the hook 116, 116′ and the hook rotates only so far as is necessary for the bottle B12 to pass over the hook 116, 116′ as illustrated in FIGS. 9B-9D. The hook 116, 116′ does not engage the closed end of the bottle B12, or other container, but merely slides along the surface such that no rotation is imparted to the container or bottle as can be seen in FIG. 9C. The container or bottle B12 then proceeds in the direction of A as shown in FIG. 9D, for example, and may be further processed.

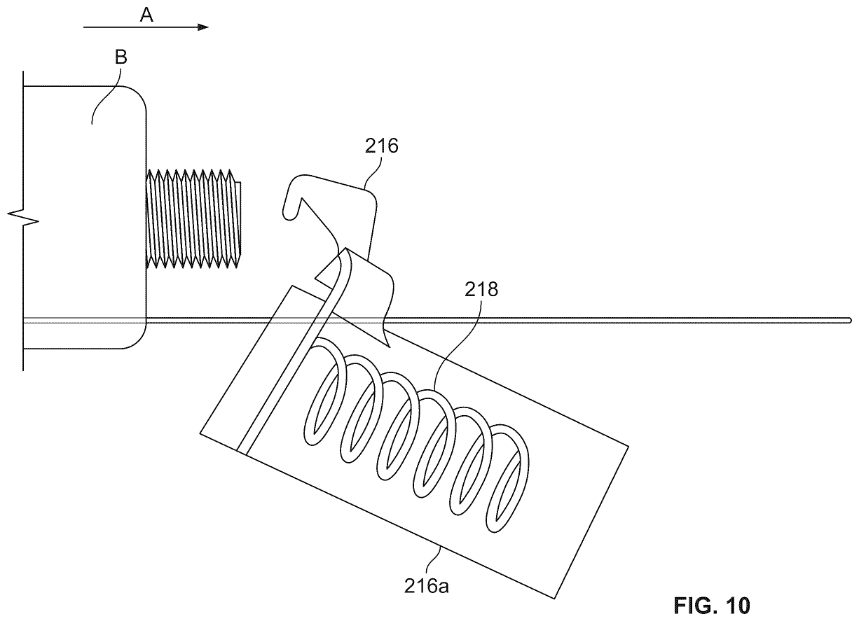

In embodiments, a hook 216 that slides along an inclined ramp 216a may be provided to engage the bottles or other containers as illustrated in FIG. 10. In embodiments, a biasing element 218 may be provided to bias the hook 216 into the start position shown in FIG. 10. As the bottle B or other container moves in direction A, the hook 216 engages the open end of the bottle or container and the hook 216 slides down the ramp 216a. As the hook 216 descends down the ramp and then stops at the end of the ramp, or other position which may be set based on the spring constant of the biasing element 218, the bottle B or other container is driven forward and pivots about the open end into the open end trailing position. The bottle B or other container may then proceed in the direction A for additional processing while the biasing element 218 returns the hook 216 to the start position to engage the next bottle or container. In embodiments, the biasing element 218 may be a spring. In embodiments, the spring constant of the biasing element 218 may be selected based on the size of the bottle or container and/or the speed of the system 1. In embodiments, the shape or size of the hook 216 may be altered to accommodate different bottles or containers. In embodiments, a length of the ramp 216a on which the hook 216 slides may be varied based on the size of the bottle or container.

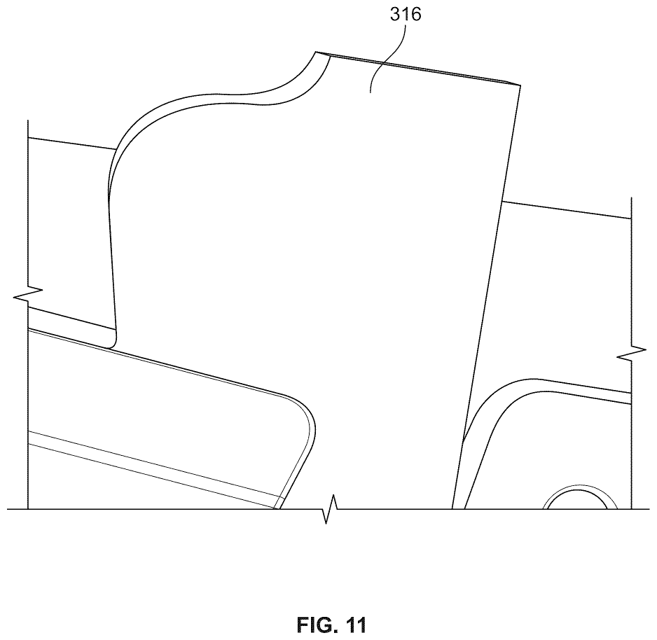

In embodiments, the hook may be modified in shape as can be seen in FIG. 11, for example. In embodiments, when a bottle B10 approaches the hook 316 in FIG. 11, the hook 316 engages the open end. In embodiments, the bottle B10 may be advanced by the belts 112 in a manner similar to that discussed above. In embodiments, the hook 316 may rotate in substantially the manner described above with respect to the hook 116 such that the bottle B10 pivots over the hook 316. In embodiments, when the bottle B12 approaches the hook 316 with the closed side first, the hook 316 rotates to allow the bottle to pass over the hook without pivoting.

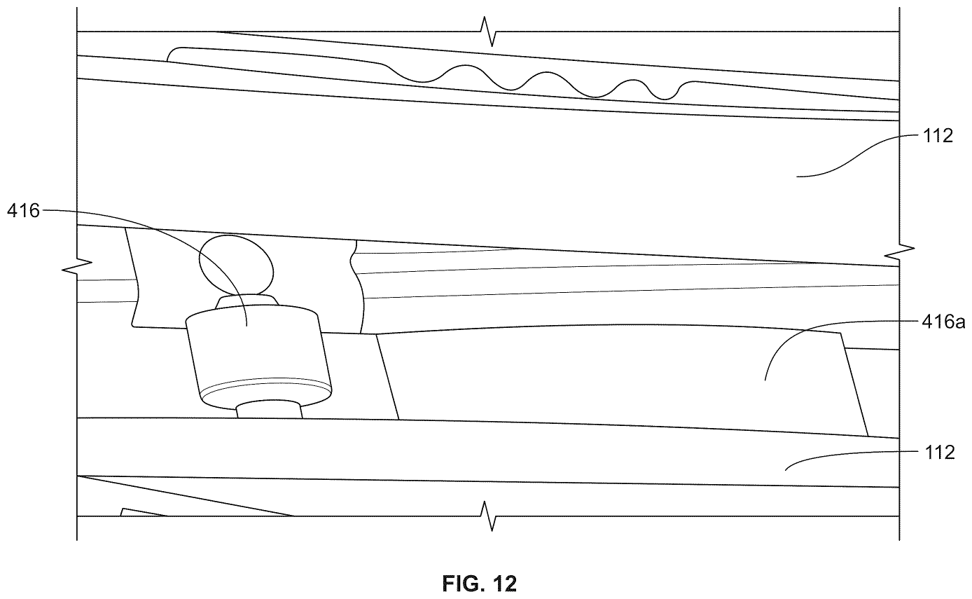

In embodiments, the hook may be further modified. In embodiments, as can be seen in FIG. 12, the hook 416 may be provided as a cylindrical shape. In embodiments, the cylindrical shaped hook 416 is mounted at least partially above the guide 20 such that it enters the open part of the bottle B10 as the bottle approaches. In embodiment, the bottle B10 then pivots around the rounded top surface of the cylindrical shaped hook 416. In the embodiments, the cylindrical shaped hook 416 is mounted in place in the path of the bottle B10 and is not mounted on a rotatable arm. In embodiments, a landing pad 416a may be provided downstream of the cylindrical shaped hook 416 to accommodate the bottle B10 after it pivots into the desired position. In embodiments, the deflector D (see FIG. 13) may be mounted above the belts 112 and positioned downstream from the cylindrical shaped hook 416 to direct the bottle B10 back down after it pivots. In embodiments, the deflector D is angled downward such that the bottle B10 is directed downward. As noted above, the deflector D may not be used.

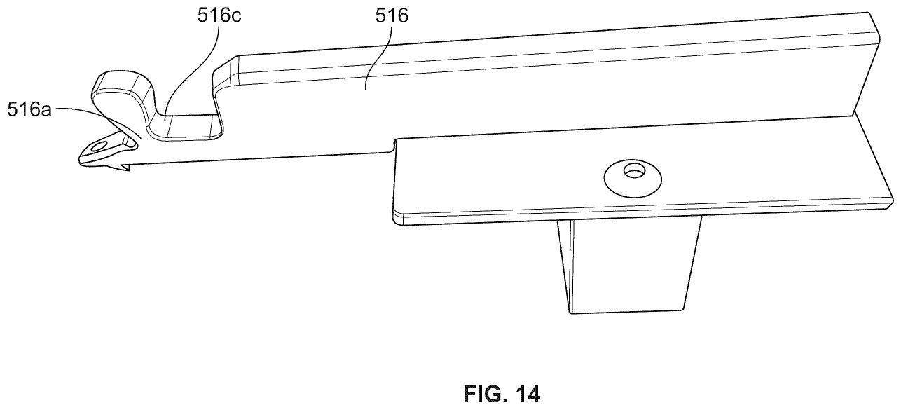

FIG. 14 illustrates another embodiment of a hook 516 that may be used in the device 10. In embodiments, the hook 516 may be mounted in the device 10 such that it extends above the guide 20. In embodiments, the hook 516 includes a notch 516a such that the hook 516 engages the opening in the open end of the bottle B10 as it approaches. As the belt 112 drives the bottle B10 forward, the open end is held by the notch such that the Bottle B10 pivots. In embodiments, a slot 516c is provided downstream from the notch 516a to accommodate the lip of the bottle B12 as it pivots. In embodiments, the hook 516 is mounted in the path of the bottles B, B10, B12 and stays in position. That is, the hook 516 does not rotate. In embodiments, when the bottle B12 approaches the hook 516, the closed end passes over the hook 516 without rotation.

In embodiments, the size and shape of the hooks 116, 116′, 216, 316, 416, 516 may be varied to accommodate bottles and openings of different types and sizes. In embodiments, the size and/or position of the notch used each hook may be modified to accommodate bottles and openings of different types and sizes. In embodiments, depending on the bottle and the open end thereof, the shape of the hook may be modified such that it does not include a notch. While the present application refers to bottles B, the orienting system and device discussed herein may be used to orient other containers that include an opening on one ends thereof.

Although the present invention has been described in relation to particular embodiments thereof, many other variations and modifications and other uses will become apparent to those skilled in the art. It is preferred, therefore, that the present invention be limited not by the specific disclosure herein.

What is claimed is:

1. A bottle orienting system comprising:
a first belt operable to advance a first bottle in a first direction;
a movable orienting device movable from a first position in which at least a portion of the movable orienting device extends upward relative to a lower surface of the bottle as it advances in the first direction and positioned in a path of travel of the first bottle and a second position in which the portion of the movable orienting device moves to a second position,
the orienting device including a hook provided in the portion of the movable orienting device that extends upward such that the hook engages a neck of the first bottle positioned in a neck forward position causing the orienting device to move and flip the bottle to a neck trailing position as the bottle moves in the first direction.

2. The bottle orienting system of claim 1, wherein the orienting device moves from the first position to the second position with the hook sliding along a bottom wall and side wall of a second bottle when the second bottle is in the neck trailing position such that the second bottle passes over the orienting device without changing orientation.

3. The bottle orienting system of claim 1, wherein the hook includes a notch portion that receives the neck of the first bottle.

4. The bottle orienting system of claim 2, wherein a size of the notch is varied to accommodate bottles of different sizes.

5. The bottle orienting system of claim 1, wherein the orienting device includes:
a rotating arm, rotating from the first position to the second position,
wherein the portion of the movable orienting device that extends upward is provided at a distal end of the rotating arm and the hook is provided at the distal end of the rotating arm;
an axel rotatably mounted in a stationary base such that the rotating arm rotates with the axel from the first position to the second position to flip the first bottle when the neck of the first bottle is engaged with the hook of the rotating arm; and
a biasing element limiting rotation of the rotating arm to a desired angle and biasing the rotating arm into the first position.

6. The bottle orienting system of claim 5, wherein the rotating arm includes a first stop extending from a surface thereof and in contact with one end of the biasing element.

7. The bottle orienting system of claim 6, wherein the base includes a second stop extending from a surface thereof and in contact with a second end of the biasing element such that the biasing element limits rotation of the rotating arm relative to the base to a desired angle and biases the rotating arm in the first position.

8. The bottle orienting system of claim 5, wherein the orienting device includes a resilient member mounted adjacent to a proximal end of the rotating arm and in contact with the proximal end when the rotating arm returns to the first position to absorb force exerted by the proximal end of the rotating arm.

9. The bottle orienting system of claim 1, further comprising a deflector element spaced away from the orienting device in the first direction and above a top surface of the first bottle to guide the first bottle downward after passing the orienting device.

10. The bottle orienting system of claim 1, further comprising a second belt, wherein the second belt is positioned opposite the first belt with the first bottle positioned between and in contact with the first belt and the second belt, wherein the first belt and the second belt advance the first bottle in the first direction.

11. The bottle orienting system of claim 1, wherein the hook extends upward and is positioned in the path of the first bottle in the first position such that it engages the neck of the first bottle as it advances in the first direction when the first bottle is in the neck leading position, and the hook slides downward along a ramp on which it is mounted to flip the first bottle to a neck trailing position as it moves to the second position.

12. The bottle orienting system of claim 11, wherein the hook orienting device moves from the first position to the second position along the ramp with the hook sliding along a bottom wall and side wall of a second bottle when the second bottle is in the neck trailing position such that the second bottle passes over the orienting device without changing orientation.

13. The bottle orienting device of claim 11, wherein the orienting device includes a biasing element biasing the hook into the first position where it will engage the neck of the first bottle in the neck forward position.

14. The bottle orienting system of claim 11, wherein the hook includes a notch that receives the neck of the bottle.

15. The bottle orienting system of claim 14, wherein a size of the notch varies to accommodate bottles of different sizes.

16. The bottle orienting system of claim 11, wherein the second position may be varied based on a strength of the biasing element.

17. The bottle orienting system of claim 11, wherein the second position may be varied based on positioning of a stop on the ramp.

18. A bottle orienting system comprising:
a first belt operable to advance a first bottle in a first direction;
an orienting device that extends upward relative to a lower surface of the bottle as it advances in the first direction and positioned in a path of travel of the first bottle,
the orienting device including a hook provided on one end thereof such that the hook engages a neck of the first bottle positioned in a neck forward position;
a transverse slot provided in the orienting device and spaced from the hook such that the bottle pivots around the hook into a neck trailing position as it moves in the first direction.

19. The bottle orienting system of claim 18, wherein the hook includes a notch that receives the neck of the bottle.

20. The bottle orienting system of claim 19, wherein a size of the notch varies to accommodate bottles of different sizes.
